(19) United States
(12) Patent Application Publication
(10) Pub. No.: US 2006/0230393 A1
(43) Pub. Date: Oct. 12, 2006

(54) Universal string analyzer and method thereof

(75) Inventors: Kyung Goo Doh, Gyeonggi-do (KR); Ouk Seh Lee, Gyeonggi-do (KR); Tae Hyoung Choi, Gyeonggi-do (KR); Bo Hyun Whang, Seoul (KR); Jo Han Chu, Seoul (KR); Sik Sang Yoo, Seoul (KR); Sung Goo Hong, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ITPlus Co., Ltd., Seoul (KR)

(21) Appl. No.: 11/393,362

(22) Filed: Mar. 29, 2006

(30) Foreign Application Priority Data
Mar. 30, 2005 (KR) 10-2005-0026727

(51) Int. Cl. G06F 9/45

(52) U.S. Cl. 717/137

(57) ABSTRACT

A universal method of analyzing a string comprises an intermediate language conversion step of converting a first data file coded in a programming language into a second data file coded in a specific intermediate language; and an analysis processing step of extracting flow information related to execution sequence from strings contained in the second data file, performing a static analysis according to the flow information, and storing variable information at a certain or each point as analysis result data.

### BACKGROUND OF THE INVENTION

The present invention relates to a program analysis, and more particularly, to a universal string analyzer and a method thereof, wherein flow information on variables of a first data file (information on variables at a certain or each point) is extracted and information considering a path along which a program follows upon actual execution of the program is statically managed.

Many enterprises have difficulties in efficiently managing new development and maintenance of important information technology (IT) assets such as application programs or data base management systems (DBMSs).

Specifically, analysis processes and documentations according to modifications of application programs and database management systems inevitably rely on manual operations. In addition, if application programs and databases are improperly modified, this leads to a computer system failure in practice.

In an enterprise that carries on businesses with computer systems, databases are almost inevitably used, and a good many of application programs are used in connection with the databases. Such application programs sensitively respond to changes in database environments and need continuous maintenance activities.

If a portion of a database is modified, all application programs affected by the modification should be modified. This is indispensable for maintaining system integrity.

Accordingly, a manager or a system developer who administers and maintains an entire system should understand all relationships among application programs (i.e., which instruction can be executed at a specific point of an application program, or which application program accesses a specific database, and the like) in order to correctly modify a database.

Accordingly, there is a rising need for a tool for establishing processes of application programs, and performing prompt and correct development and maintenance activities through analysis of modification effects and standardization of quality control using automated solutions.

On the other hand, a conventional analysis program for analyzing a certain program extracts information on programs, functions, objects, or the like through a case-by-case analysis according to coding patterns only in case of programs which contain the same language or embedded languages and of which grammar can be checked.

However, in electronic computing system environments that become more and more complicated, data used for heterogeneous service calls between files or objects exist as variables while a program is running. Thus, diverse data cannot be found only by checking grammar of a specific language.

In addition, since a conventional analysis program does not store and manage analyzed data of a target program to be analyzed, there is inconvenience in that a corresponding program and associated programs should be analyzed every time in order to get information on a desired variable.

### SUMMARY OF THE INVENTION

Accordingly, an object of the present invention is to provide a universal string analyzer and a method thereof, wherein even in a state where a program is not being executed, values that can be information on variables of a program at a certain or each point upon actual execution of the program can be statically estimated and managed.

According to an aspect of the present invention for achieving the object, a target program to be analyzed is converted into a form coded in a certain intermediate language so as to be inputted into a universal string analyzer. Then, information on a variable at a certain or each point of the program is extracted through a static analysis from the target program, which has been converted into the form coded in the intermediate language.

According to another aspect of the present invention, there is provided a universal string analyzer, comprising an intermediate language conversion unit designed for each programming language to convert a first data file coded in a programming language into a second data file coded in a specific intermediate language; and an analysis processing block for extracting flow information related to execution sequence from strings contained in the second data file, performing a static analysis according to the flow information, and storing variable information at a certain or each point as analysis result data.

According to a further aspect of the present invention, there is provided a universal method of analyzing a string, comprising a parsing step of reconfiguring a string of a data file coded in a programming language into abstract syntax tree data representing a structure of a target program to be analyzed, through lexical and syntax analyses; a preprocessing step of extracting flow information from the parsed data, and creating a flow graph; and a string analysis step of statically analyzing the preprocessed data, extracting variable information estimated at each point based on the flow graph, and preparing analysis result data.

According to a still further aspect of the present invention, there is provided a computer-readable recording medium on which a program for executing functions in a computer including a microprocessor is recorded, wherein the functions comprise an intermediate language conversion function of converting a first data file coded in a programming language into a second data file coded in a specific intermediate language; and an analysis processing function of extracting flow information related to execution sequence from strings contained in the second data file, performing a static analysis according to the flow information, and storing variable information extracted at a certain or each point as analysis result data.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a view showing the configuration of a computing system for performing a string analysis according to an embodiment of the present invention;

FIG. 2 shows a functional block diagram illustrating a universal string analyzer according to an embodiment of the present invention;

FIG. 3 is a view showing a first data file inputted into the universal string analyzer according to the embodiment of the present invention;

FIGS. 4a and 4b are views showing a second data file coded in an intermediate language, which is converted from the first data file shown in FIG. 3;

FIGS. 5a and 5b show flow graphs of the second data file shown in FIGS. 4a and 4b;

FIG. 6 shows a functional block diagram illustrating a string analysis unit shown in FIG. 2;

FIGS. 7a and 7b show data of analysis results of the first data file shown in FIG. 1;

FIG. 8 is a flowchart illustrating the operation of the universal string analyzer shown in FIG. 2;

FIG. 9 is a flowchart illustrating the operation of the string analysis unit shown in FIG. 2;

FIG. 10 is a functional block diagram illustrating a universal string analyzer according to another embodiment of the present invention;

FIG. 11 is a flowchart illustrating the operation of a universal string analyzer according to a further embodiment of the present invention;

FIG. 12 is a flowchart illustrating the operation of a universal string analyzer according to a still further embodiment of the present invention; and

FIG. 13 is an exemplary view showing an output of a universal string analyzer according to a still further embodiment of the present invention.

### DETAILED DESCRIPTION OF THE INVENTION

Hereinafter, preferred embodiments of the present invention will be described with reference to the accompanying drawings.

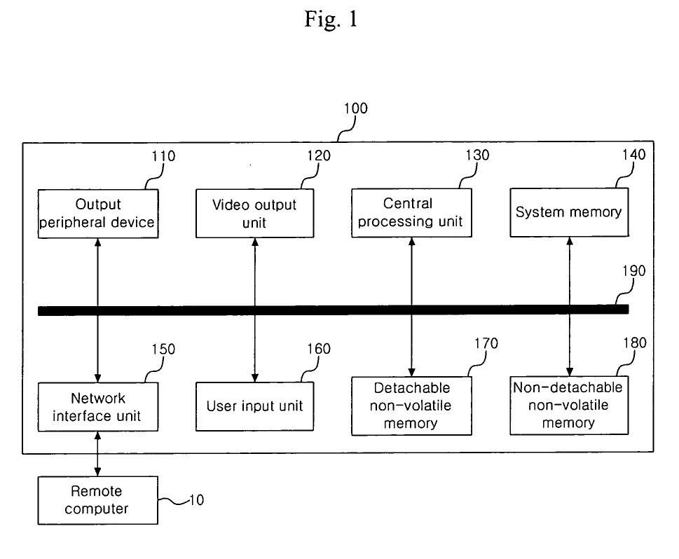

FIG. 1 is a view showing the configuration of a computing system for performing a string analysis according to an embodiment of the present invention.

The computing system shown in FIG. 1 is implemented as a general purpose computer in accordance with an embodiment of the present invention. However, the present invention is not limited thereto but the computing system may be a computing apparatus developed to perform application programs based on known techniques.

Here, computing apparatuses are apparatuses capable of executing application programs, such as personal computers (PCs), automatic teller machines (ATM), server computers, hand-held or laptop apparatuses, multi-processor systems, microprocessor-based systems, programmable commercial electronic products, network PCs, appliances, lights, environmental control elements, mini computers, and main frame computers. However, it is not limited thereto.

In addition, since a string analyzer according to an embodiment of the invention can be operated in an environment of a network-type host service with a very small amount of client resources, it can be operated in a network/bus such as an object embedded in an appliance, a network environment that acts only as an interface to other computing apparatuses or objects, or a distributed computing environment where tasks are linked through a communication network/bus or other data transmission media.

At this time, a program module in a distributed computing environment can be located at both a local and a remote computer storage medium. A client node operates as a server node, and thus, can perform the operation of the string analyzer according to the embodiment of the present invention.

In other words, an environment in which data can be stored or retrieved is a desirable or appropriate environment for the string analyzer according to the embodiment of the present invention.

Therefore, an appropriate computing system 100 that can operate the string analyzer according to the embodiment of the present invention is illustrated by way of example in FIG. 1. However, as described above, the computing system 100 is only an example of an appropriate computing system, and it is not intended to limit the usage range or functional range for performing the operation of the string analyzer according to the embodiment of the invention.

Particularly, the computing system 100 should not be construed as having certain dependency or requirements related to any one or a combination of components shown in an exemplary operating environment.

Referring to FIG. 1, an exemplary system for performing the operation of the string analyzer according to the embodiment of the present invention includes a general purpose computing apparatus in the form of a computer system.

The computer system 100 comprises an output peripheral device 110, a video output unit 120, a central processing unit 130, a system memory 140, a network interface unit 150, a user input device 160, a detachable non-volatile memory 170, a non-detachable non-volatile memory 180, and a system bus 190.

The output peripheral device 110 includes a speaker, a printer or the like.

The video output unit 120 includes a monitor, or another type of display unit.

The central processing unit 130 controls the entire operation of the computer system 100, and activates functional software modules for loading a string analyzer program stored in the computer system 100 through computer storage media or communication media such as the system memory 140, the detachable non-volatile memory 170 and the non-detachable non-volatile memory 180, and performing an analysis operation.

At this time, the system memory 140, the detachable non-volatile memory 170, and the non-detachable non-volatile memory 180 are implemented using information-storing techniques, such as computer readable instructions, data structures, program modules, and other data. These are computer readable media that can be accessed by the central processing unit 130.

Here, a program module contains functional program modules of the string analyzer according to the embodiment of the present invention.

At this time, the computer readable media include a RAM, a ROM, an EEPROM, a flash memory or other memories, a CD-ROM, a compact disk-rewritable digital versatile disk (CD-RW DVD) or other optical disk memory devices, a magnetic cassette, a magnetic tape, a magnetic disk memory device or other magnetic memory devices, a medium that can be accessed by the computer system 100 and store desired information therein, and a communication medium.

At this time, the communication medium may be generally a transfer medium implemented to transmit computer readable instructions, data structures, program modules, data and the like through a modulated data signal such as a carrier wave or other transmission mechanisms.

At this time, the term “modulated data signal” means a signal with one or more characteristic sets, or a signal modified by means of encryption of information within the signal, and the like.

For example, the communication medium includes, but not limited to, a wired medium such as a wired network or direct wired connection, and a wireless medium such as sound, RF, infrared rays, and other wireless media. All combinations of the media described above should also be included within the range of the computer readable medium.

The system memory 140 includes a computer memory device medium in the form of a volatile and/or non-volatile memory, such as a read only memory (ROM) and a random access memory (RAM).

Generally, the read only memory (ROM) stores a basic input/output system (BIOS) containing basic routines for assisting transmission of information between components of the computer system 100 upon booting of the computer system. The random access memory (RAM) stores data and/or program modules operated by the central processing unit 120.

At this time, the program modules include program modules of the string analyzer according to the embodiment of the present invention, operating systems, application programs, other program modules, and program data.

The detachable non-volatile memory 170 can be a non-volatile magnetic disk, a CD-ROM, a non-volatile optical disk including a CDRW or another optical medium, a magnetic tape cassette, a flash memory card, a DVD, a digital video tape, a solid state RAM, a solid state ROM, or the like.

The non-detachable non-volatile memory 180 may be, for example, a hard disk for writing data in a non-volatile magnetic medium or reading data therefrom.

The hard disk stores an operating system, application programs, other program modules, and program data. Here, the components stored in the hard disk may be the same as or different from the operating system, application programs, other program modules, and program data stored in the system memory 140.

The network interface unit 150 performs an operation for connecting the computer system 100 to one or more remote computers 10.

The computer system 100 can be operated in a networked or distributed environment using a logical connection to one or more remote computers 10 through the network interface unit 150.

The remote computer 10 may be another personal computer, a server, a router, a network PC, a peer device, or another common network node, and may generally include most or all of the elements explained above in connection with the computer system 100.

The logical connection may be a LAN or WAN and may include other networks/buses. Such a networking environment is a typical one in a computer network, intranet, or Internet extending over homes, offices, and whole enterprises.

When used in a LAN networking environment, the computer system 100 is connected to a LAN through a network interface or an adapter. When used in a WAN networking environment, the computer system 100 generally includes a modem or other means for establishing communication in a WAN such as the Internet.

With the development of communication technologies, a variety of distributed computing frameworks have been and are being developed while being focused on personal computing and the Internet. Regardless of personal or business users, they are provided with web-enabled interfaces that enables seamless interoperability between applications and computing devices, so that computing activities can be oriented to web browsers or networks.

For example, the NET platform of the Microsoft includes a server, block implementation services such as web-based data storage, and downloadable device software.

Herein, exemplary embodiments of the present invention are explained in connection with software residing in a computing device. However, one or more portions of the present invention may be implemented through a ‘middle-man’ object among the operating system, application program interfaces (API), a co-processor, a display device, and requested objects so that the operation of the present invention can be supported by or accessed through all the .NET languages and services, and may be implemented in other distributed computing frameworks as well.

The user input device 160 is a device for inputting commands and information into the computer system 100 and may be a keyboard, a mouse, a touchpad, a microphone, a joystick, a game pad, a satellite antenna, a scanner or the like.

Such a user input device 160 is generally connected to the central processing unit 130 through the system bus 190 but may be connected through other interfaces and bus structures, such as a parallel port, a game port or a universal serial bus (USB).

The system bus 190 may be any one of several types of bus structures including a local bus that uses any one of a memory bus or memory controller, a peripheral device bus, and several kinds of bus architectures.

Such a structure includes, but not limited to, an industry standard architecture (ISA) bus, a micro channel architecture (MCA) bus, an enhanced ISA (EISA) bus, a video electronics standard association (VESA) local bus, a peripheral component interconnect (PCI) bus also known as a mezzanine bus, and the like.

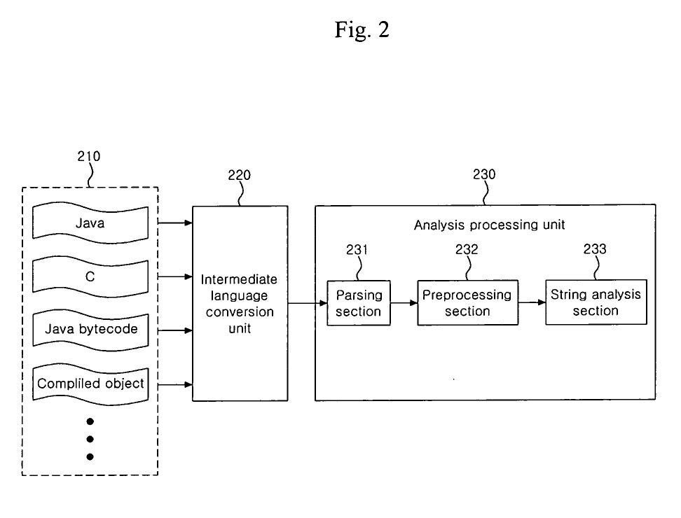

FIG. 2 is a functional block diagram of a string analyzer operated in the computing system shown in FIG. 1.

Referring to FIG. 2, the string analyzer according to an embodiment of the present invention comprises an intermediate language conversion unit 220 for converting a target program to be analyzed into a certain intermediate language (IL) form, and an analysis processing unit 230 for performing a string analysis on the data converted into a form coded in a certain intermediate language, and extracting information on variables.

The analysis processing unit 230 comprises a parsing section 231 for receiving the target program converted into the form coded in the intermediate language and reconfiguring the program into data in an abstract syntax tree (AST) form through lexical and syntax analyses; a preprocessing section 232 for converting the data in the abstract syntax tree form into a flow graph form so as to find flow information; and a string analysis section 233 for analyzing the data in the flow graph form through a static analysis method and extracting analysis result data.

Hereinafter, for the sake of convenience, a target program to be analyzed in the present invention is referred to as a first data file 210, and a file converted from the first data file 210 into a form coded in a certain intermediate language by the intermediate language conversion unit 220 is referred to as a second data file.

At this time, the first data file 210 can be coded in various kinds of programming languages, such as Java, C++, C#.NET, PL/1, COBOL, JCL, JSP, Delphi, Visual Basic, PowerBuilder, Java bytecode coded in an intermediate language of a Java virtual machine, EXE coded in a machine language, DLL, and the like.

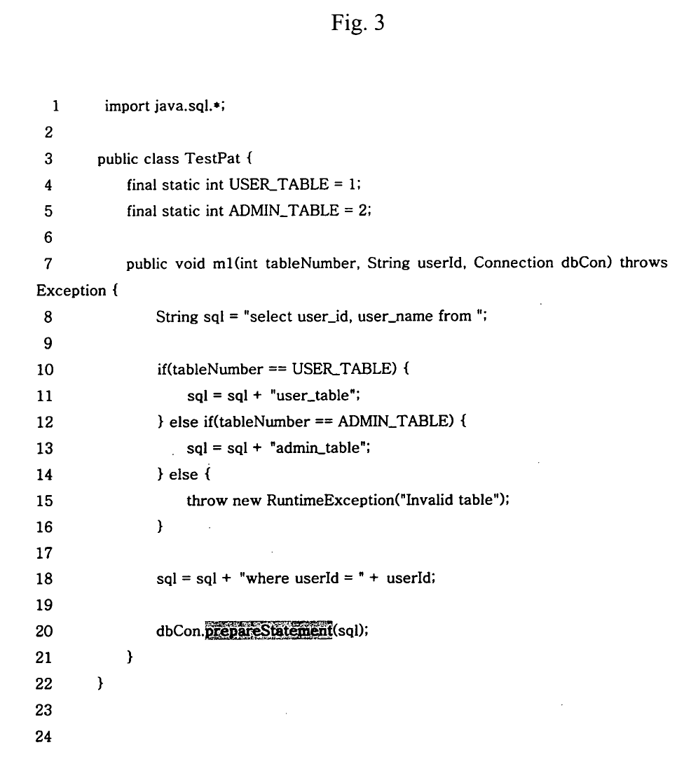

Referring to FIG. 3, there is shown a view illustrating an example of application of the string analyzer according to the embodiment of the present invention, wherein it is possible to see a first data file that will be inputted into the intermediate language conversion unit 220 and then converted into a form coded in an intermediate language. At this time, the first data file is coded in Java language.

As described above, since the first data file 210 can be coded in various kinds of programming languages, a separate analyzer is needed for each programming language.

Therefore, in the string analyzer according to the embodiment of the present invention, the intermediate language conversion unit 220 is provided with a conversion module, which converts the first data file 210 into a second data file, according to each of programming languages, if necessary.

The intermediate language conversion unit 220 unifies the first data file 210, which has been coded in a certain programming language, with an intermediate language code through the conversion module provided therein.

At this time, the first data file 210 unified with the intermediate language code becomes the second data file.

The intermediate language (hereinafter, referred to as a “0 language”) used in the universal string analyzer according to the embodiment of the present invention is designed to include characteristics of a plurality of programming languages based on known techniques.

First, the syntax domain of the [symbol] language is defined as follows.
nεNum a numeric value
cεChar a character
sεString a string
xεVar a local variable
bopεBOp a binary operator
uopεUOp a unary operator
fεField a field variable or method
clsεClass a class
labεLab a syntactic label

The abstract syntax structure of the [symbol] language is as follows.
Identifier id ::=x|x.f|x[e]|cls.f
Expression e ::=n|c|s|id|e bop e|uop e|cls.f(x, e*)
         |new cls|new τ [n⁺]|unit
Statement stmt ::=id:=e|if e then stmt else stmt
         |while e do stmt|for stmt e e stmt|goto lab
         |lab:stmt|return e|let τx in stmt
         |stmt; stmt
Declaration dec ::=τ cls.f(τx)* {stmt}|τ cls.f|cls {(τf)*}
Program prgm ::=dec*
Type τ ::=cls|τ[ ]|string|int|ref τ

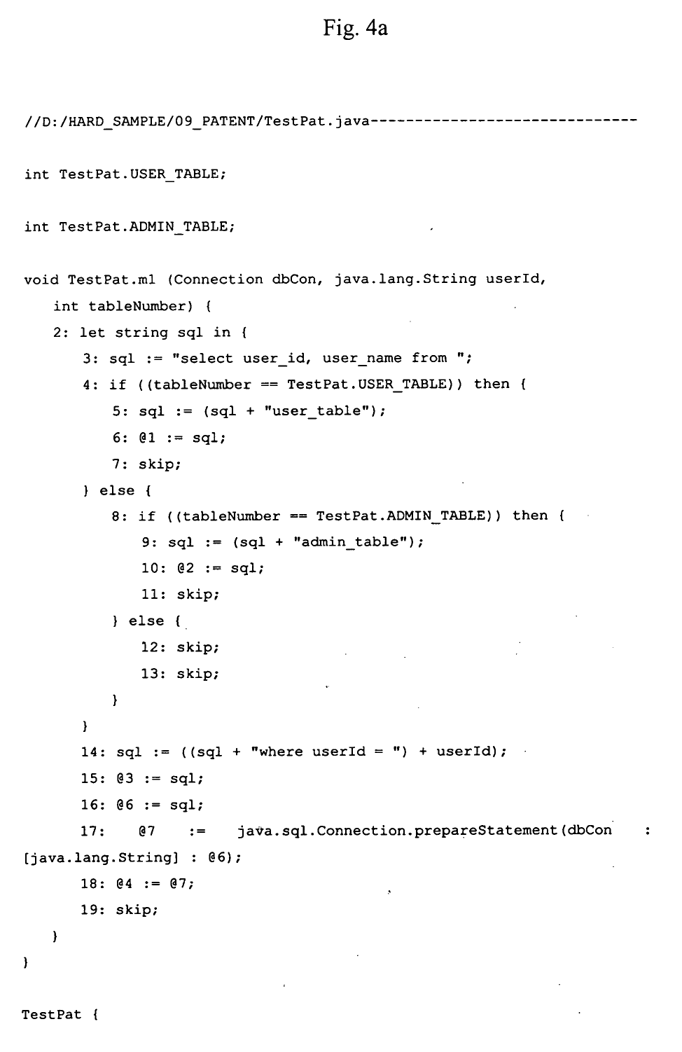

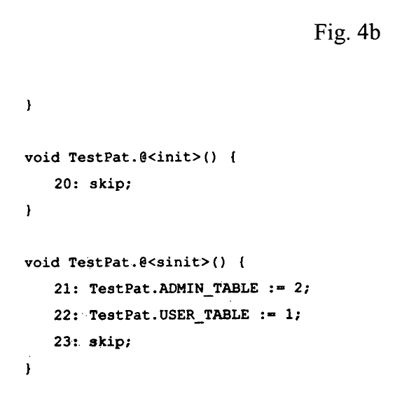

Referring to FIGS. 4a and 4b, there is shown a second data file in the [symbol] language into which the intermediate language conversion unit 220 has converted the first data file coded in Java language (shown in FIG. 3).

The analysis processing unit 230 receives the second data file and extracts analysis result data composed of information on variables at a certain or each point.

At this time, a variable has an address in the memory where the data are stored. Therefore, the analysis processing unit 230 reads the second data file line by line as strings, extracts a variable at a certain position on a certain line and data of the variable, and prepares them into analysis result data.

As a result, the analysis result data contains information on at least one of a static variable, a general variable, an object, a thread, a function, a variable and a function in an object, and a variable and a parameter in a function at each position. Such information will be herein referred to collectively as ‘variable information’.

To this end, the analysis processing unit 230 includes a parsing section 231 for reading strings in the second data file and reconfiguring the strings into abstract syntax tree data representing the structure of a program, a preprocessing section 232 for creating a flow graph, and a string analysis section 233 for preparing the variable information at each point into analysis result data based on the flow graph.

First, the parsing section 231 divides strings in a program, which has been converted into a form coded in an intermediate language, on a meaningful token basis through a lexical analysis. Then, the parsing section 231 reconfigures the listed tokens into a data structure with a tree form through a syntax analysis, and thus prepares an abstract syntax tree.

For example, assume that there is a long string of “if (a==1) then a=5; else a=10”.

The parsing section 231 divides the string into the following meaningful tokens through a lexical analysis:
“if”, “(”, “a”, “==”, “)”, “then”, “a”, “=”, “5”, “;” . . .

After dividing the string into the tokens, the parsing section 231 recognizes, through a syntax analysis, that the string is an “if” statement having a condition of a=1 by analyzing the syntax of the listed tokens, and converts the tokens into an abstract syntax tree form with a structure.

Although an abstract syntax tree that represents the structure of tokens in such a manner shows the entire form of a program, it does not show an execution flow. Accordingly, the parsing section 231 transfers the abstract syntax tree to the preprocessing section 232 in order to add flow information related to actual execution sequence.

The preprocessing section 232 receives data in the form of an abstract syntax tree from the parsing section 231, and extracts flow information showing the dependency and precedence between individual operations in the program. Then, the preprocessing section 232 converts the extracted flow information into a flow graph form for easy analysis.

At this time, the flow graph can be expressed as follows, using nodes and edges in accordance with an embodiment of the present invention.
Graph=Node×P(Edge)
Node=Label→Attr
Edge=Label×Label
Label l=N

Here, the graph is configured as a set of edges connected between the nodes. The node is a set of basic blocks in a program, which are formed of labels expressed in natural numbers and attributes (Attr) of corresponding blocks, and the edge is a set of flows connecting the nodes.

For example, if flow information is constructed according to actually executable execution sequence in the following program:
1: if(a==1)
2: then a=5;
3: else a=10;
4: print a;
   the following data in the form of a flow graph are created:
(1-2), (2-4), (1-3), (3-4).

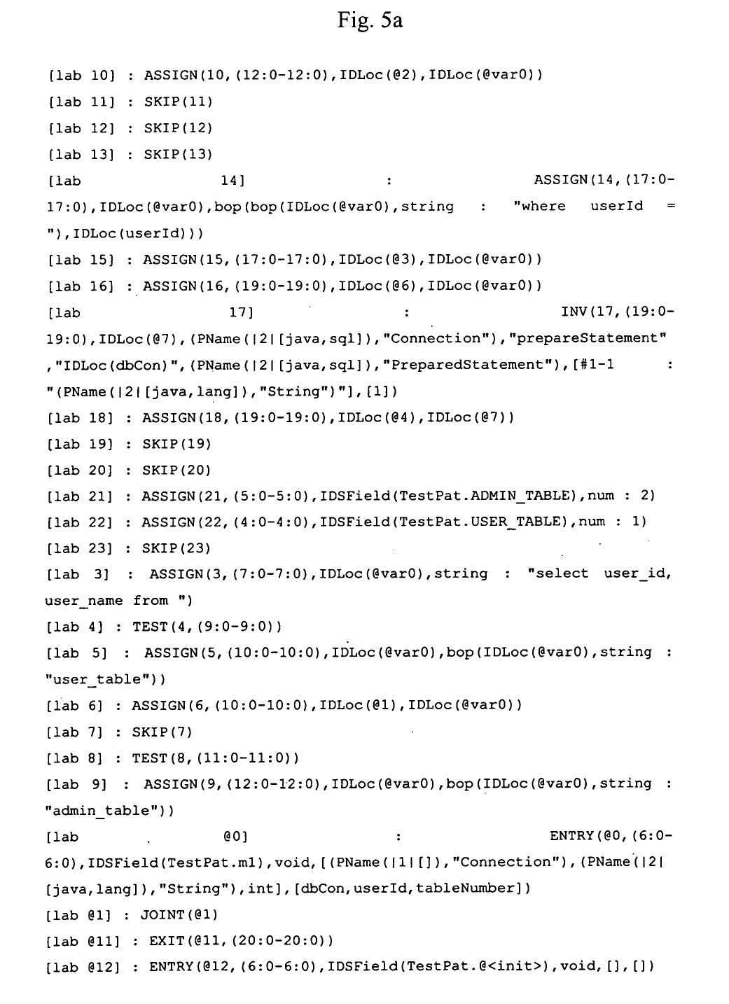

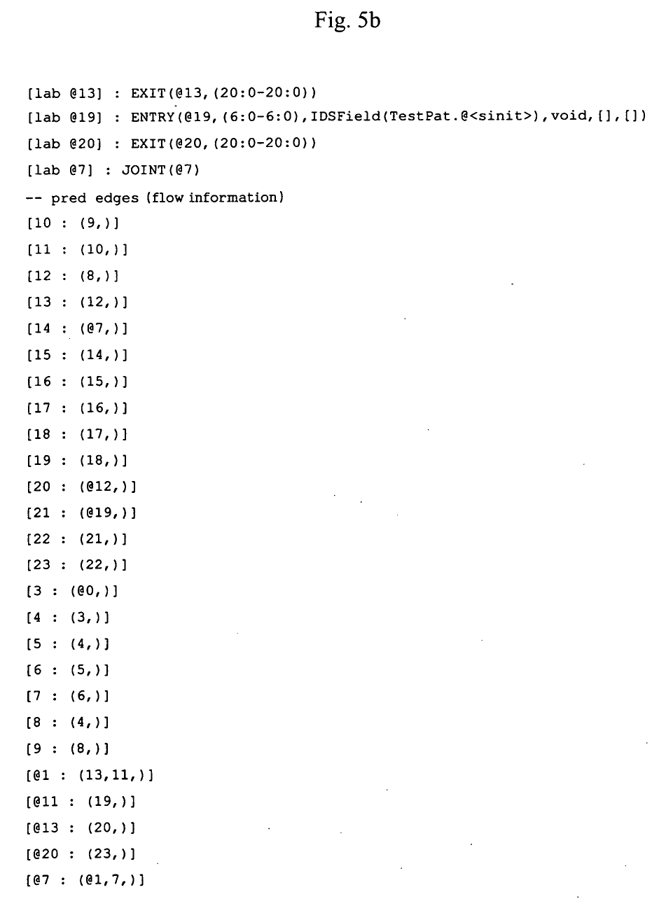

Referring to FIGS. 5a and 5b, there is shown a flow graph prepared by the preprocessing section 232 based on the second data file (shown in FIGS. 4a and 4b) to describe a set of nodes and a flow of a program.

The string analysis section 233 receives data prepared in the form of a flow graph from the preprocessing section 232, performs an analysis for each node through a static analysis technique until a point is determined to be a fixed point, and stores the extracted result values of the nodes as analysis result data.

At this time, the fixed point refers to a point where the value of a variable to be analyzed is estimated to be a fixed value. A point is determined to be a fixed point if the result environment of a previous node is the same as the result environment of a current node, or the position of a current node corresponds to a point to be analyzed while the analysis is performed.

Then, the static analysis refers to preexamination of a characteristic of interest during execution of a program, without executing the program. The static analysis may be constant propagation, aliasing analysis, exception analysis, static slicing, control flow analysis, abstract interpretation, set-based analysis, or the like according to the purpose or technique of the static analysis, and is mainly used for optimization or stability proof of a program.

The string analysis section 233 according to an embodiment of the present invention is implemented to estimate in advance a value that a variable in a corresponding program can have, by means of the abstract analysis method among those static analysis methods.

At this time, the abstract analysis method is a method that performs a program in an abstract space expressed as a lattice and then estimates a concrete value using an abstract value containing the values of all cases.

In this methodology, since an abstract space is used and information of interest always increases, analysis of a program is always completed within a finite period of time. In addition, the relationship between concrete semantics and abstract semantics is defined as a function of abstraction and concretization that always meet stability conditions, thereby ensuring correctness of analysis of a program.

Concrete domains of concrete semantics defining concretization of the abstract analysis method are shown below.
rεRef=a specific location in memory
vεValue=Num+String+Ref
oεObj=Field→Value
arrεArray=Num→Value
hεHeap=Ref→Obj+Array
evₗεLocalEnv=Var→Value
evₛεStaticEnv=(Class×Field)→Value
evεEnv=LocalEnv×StaticEnv×Heap
ctblεClassTbl=Class→Obj
mtblεMethodTbl=(Class×Field)→Graph
gtblεGlobalTbl=ClassTbl×MethodTbl

Here, Ref is the address of a specific location in a memory. Value may be Num that is a numeric value, String that is a string, or Ref that is an address. Obj is in the form of a function in which Field is inputted and Value is outputted. Array is in the form of a function in which Num is inputted and Value is outputted. Heap is in the form of a function in which an address is inputted and the Obj function or the Value function is outputted.

LocalEnv is in the form of a function for calculating a local variable, wherein a variable is inputted and Value outputted. If a tuple of Class and Field is inputted into the StaticEnv function, Value is outputted. Env serves to store the environment of the analyzer, which is in a 3-tuple form of local environment, static environment, and Heap.

ClassTbl means a class table that is in the form of a function in which Class is inputted and Obj function is outputted. MethodTbl means a method table that is in the form of a function in which a tuple of Class and Field is inputted and a graph of Class and Field is configured and outputted. GlobalTbl is a global table in the form of a tuple of ClassTbl and FieldTbl.

Abstract domains of abstract semantics defining abstraction of the abstract analysis method are shown below. The domains defined below show an approximate range of values that can be obtained as results of the analysis.
\hat{n}ε [symbol] =P(Num)_{≦k}∪{τ}
ŝε [symbol] =L_{G}(s)∪{⊥} Grammar s→ε|c|s+s|ss| [symbol] |τ
\overline{s}ε [symbol] =without any+⊂ [symbol]
\hat{r}ε [symbol] =P(Label)
\hat{v}ε [symbol] = [symbol] + [symbol] + [symbol]
ôε [symbol] =Field→ [symbol]
[symbol] ε [symbol] =Num→ [symbol]
uεUnique=Bool
ĥε [symbol] =Label→( [symbol] + [symbol] )×Unique
[symbol] ε [symbol] =Var→ [symbol]
[symbol] ε [symbol] =(Class×Field)→ [symbol]
[symbol] ε [symbol] = [symbol] × [symbol] × [symbol]
tblₘεMethodTbl=(Class×Field)→Graph
[symbol] ε [symbol] =Class→ [symbol]
[symbol] = [symbol] ×MethodTbl
\hat{ξ}ε [symbol] =Label→ [symbol]
\hat{δ}ε [symbol] = [symbol] ×

[symbol]

First, [symbol] is a power set of numeric values derived as analysis results, and a limit value “k” is taken into account in order to confirm whether or not to continue gathering numeric values even when the number of the numeric values becomes k or more. In addition, [symbol] also contains τ, which means unknown, as an element. [symbol] is a set of strings that can be derived as analysis results, and contains a language set, which is a set of strings that can be created by an expressed grammar s, and the ⊥, which means there is no result value, as elements.

[symbol] means a string normal form. This is a subset of [symbol] and includes all strings that can be created by grammars excluding s+s from grammars for configuring [symbol] . [symbol] is a power set of labels expressed in natural numbers. [symbol] may be [symbol] [symbol] and [symbol] all of which are abstract values.

[symbol] is a function in which corresponding [symbol] is outputted when an object name (Field) is inputted, and [symbol] is a function in which a [symbol] value is outputted when [symbol] is inputted.

Unique is not an abstract value but has only two values of “true” and “false”, which is used in [symbol] [symbol] is in the form of a function in which a label is inputted and a tuple of [symbol] and Unique, or [symbol] and Unique is outputted.

If the value of Unique is “true”, which means there is one concrete object of [symbol] or [symbol] of a label pointed by [symbol] the value of [symbol] or [symbol] can be modified. However, if the value of Unique is “false”, which means there are two or more concrete objects of [symbol] or [symbol] of a label pointed by [symbol] the value of [symbol] or [symbol] cannot be modified, and a value currently desired to be modified is added to a set of previous values.

[symbol] outputs corresponding [symbol] when a variable name (Var) is inputted in order to get the contents of a local variable. [symbol] outputs [symbol] when a class name (Class) and a variable name (Field) is inputted in order to get the contents of a static variable.

[symbol] contains the local variable environment ( [symbol] ), the static variable environment ( [symbol] ), and heap ( [symbol] ). If a class (Class) and a method name (Field) are given, the MethodTbl outputs a corresponding method in the form of a flow graph (Graph). [symbol] a table in which objects of a basic state are stored by class, which is static information.

[symbol] comprises [symbol] and MethodTbl. [symbol] is a map needed since an environment ( [symbol] ) exists for each label, and outputs a corresponding [symbol] value when a label (Label) is inputted. Finally, [symbol] comprises [symbol] and [symbol] .

The relationship between the abstract value and the concrete value analyzed with the domains defined above is as follows.
number γ(T)=Num
   γ(N)=N
string γ(⊥)=Ø
   γ(ε)={ε}
   γ(c)={c}
   γ(S₁+S₂)=γ(S₁)U γ(S₂)
      γ(S₁S₂)=γ(S₁)·γ(S₂)
      when S₁.S₂={S₁S₂|S₁εS₂, S₁εS₂}
   γ(*)=Charᵢ*
   γ(T)=String
sequence S₁ [symbol] S₂ iff γ(S₁)⊂γ(S₂)

At this time, the function γ serves to convert an abstract value into a concrete value.

Accordingly, if the abstract value of the function γ is all numerals, the concrete value is Num. If the abstract value of the function γ is a set of natural numbers, the concrete value is also a set of natural numbers. If the abstract value of the function γ is a string, the concrete value is a value that a corresponding string can have. If the function has both S₁ and S₂ as abstract values, the concrete value is the concatenation of the concrete values of corresponding S₁ and S₂.

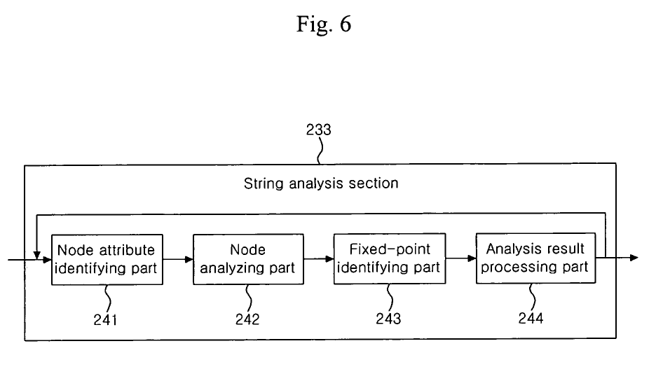

FIG. 6 shows a functional block diagram of the string analysis section 233 shown in FIG. 2.

Referring to FIG. 6, the string analysis section 233 receives a flow graph from the preprocessing section 232 and performs a static analysis for each node according to the flow sequence.

To this end, the string analysis section 233 includes a node attribute identifying part 241 for receiving a current node and an environmental value of the current node and identifying attributes of the current node; a node analyzing part 242 for statically analyzing the current node; a fixed-point determining part 243 for determining whether a point where the current node is analyzed is a fixed point; and an analysis result processing part 244 for outputting an analysis result value of a corresponding node received from the fixed-point determining unit 243 as analysis result data if the point where the current node is analyzed is a fixed point.

First, the node attribute identifying part 241 receives a current node and an environment value of the current node from a flow graph, and identifies attributes of the node.

Here, attributes of a node are classified as follows according to a role performed by each node of the flow graph.
[Node attributes]
Entry node: means a start point of a function
Assign node: means an assignment statement
Object node: means a point of object assignment
Array node: means a point of array assignment
Inv node: means an environment of a point where a function is called
Test node: means a test of conditional statements of IF, Loop
Join node: means a point where environments are joined in case of true or false in an IF statement
Loop join node means a point where environments are joined after performing the Loop body in a Loop statement (while, for)
Return node: means termination of a function
Exit node: means termination of a program

The node analyzing part 242 performs an analysis according to the attributes of a current node identified by the node attribute identifying part 241 using a static analysis method. In the present invention, the static analysis is performed using the abstract analysis method.

Accordingly, the node analyzing part 242 performs the following abstract operations in order to extract an abstract value of a variable to be analyzed.

$$concatenation \begin{matrix}\hat{s} \cdot {\hat{s}}^{′} = \hat{s} {\hat{s}}^{′} & \\ \hat{s} \cdot {\hat{s}}^{′} = ⊥ & where \hat{s} or {\hat{s}}^{′} is ⊥\end{matrix}$$

$$join \begin{matrix}\hat{s} ⊔ {\hat{s}}^{′} = \hat{s} + {\hat{s}}^{′} \\ \hat{n} ⊔ {\hat{n}}^{′} = \{ \begin{matrix}\hat{n} ⋃ {\hat{n}}^{′} & if \vert \hat{n} ⋃ {\hat{n}}^{′} \vert ⩽ k \\ ⊤ & otherwise\end{matrix} \\ \hat{r} ⊔ {\hat{r}}^{′} = \hat{r} ⋃ {\hat{r}}^{′} \\ \hat{o} ⊔ {\hat{o}}^{′} = λ f ∈ dom ( \hat{o} ) ⋃ dom ( {\hat{o}}^{′} ) . \hat{o} ( f ) ⊔ {\hat{o}}^{′} ( f ) \\ \hat{arr} ⊔ {\hat{arr}}^{′} = λ n . \hat{arr} ( n ) ⊔ {\hat{arr}}^{′} ( n ) \\ ( \hat{o} , u ) ⊔ ( {\hat{o}}^{′} , {u}^{′} ) = ( \hat{o} ⊔ {\hat{o}}^{′} , u ⋀ {u}^{′} ) \\ ( \hat{arr} , u ) ⊔ ( {\hat{arr}}^{′} , {u}^{′} ) = ( \hat{arr} ⊔ {\hat{arr}}^{′} , u ⋀ {u}^{′} ) \\ \hat{l υ} ⊔ {\hat{l υ}}^{′} = λ x ∈ Var . ( \hat{l υ} ( x ) ⊔ {\hat{l υ}}^{′} ( x ) ) \\ \hat{s υ} ⊔ {\hat{s υ}}^{′} = λ cls ∈ Class . λ f ∈ Field . ( \hat{s υ} ( cls , f ) ⊔ {\hat{s υ}}^{′} ( cls , f ) ) \\ \hat{h} ⊔ {\hat{h}}^{′} = λ l ∈ Lab . ( \hat{h} ( l ) ⊔ {\hat{h}}^{′} ( l ) )\end{matrix}$$

$$widening$$

$$\overline{s} ∇ {\overline{s}}^{′} = {\overline{s}}_{pre} * {\overline{s}}_{post} where \{ \begin{matrix}{\overline{s}}_{pre} {\overline{s}}_{1} = \overline{s} , & {{s}^{ \_}}_{ pre} {{s}^{ \_}}_{ 1}^{ ′} = { {s}^{ \_}}^{ ′} , \\ {\overline{s}}_{2} {\overline{s}}_{post} = {\overline{s}}_{1} , & {{s}^{ \_}}_{ 2}^{ ′} {{s}^{ \_}}_{ post} = { {s}^{ \_}}_{ 1}^{ ′} , \\ {{s}^{ \_}}_{ pre} {{s}^{ \_}}_{ post} \neq e . & ⊤ is not in {\overline{s}}_{2} , {\overline{s}}_{2}^{′} ,\end{matrix} \\ ★ {\overline{s}}_{pre} , {\overline{s}}_{pre} , {\overline{s}}_{post} , {\overline{s}}_{post} have maximum length , respectively \\ \overline{s} ∇ {\overline{s}}^{′} = {\overline{s}}_{pre} ⊤ {\overline{s}}_{post} where \{ \begin{matrix}{\overline{s}}_{pre} {\overline{s}}_{1} = \overline{s} , & {{s}^{ \_}}_{ pre} {{s}^{ \_}}_{ 1}^{ ′} = { {s}^{ \_}}^{ ′} , \\ {\overline{s}}_{2} {\overline{s}}_{post} = {\overline{s}}_{1} , & {{s}^{ \_}}_{ 2}^{ ′} {{s}^{ \_}}_{ post} = { {s}^{ \_}}_{ 1}^{ ′} , \\ {{s}^{ \_}}_{ pre} {{s}^{ \_}}_{ post} \neq e . & ⊤ is not in {\overline{s}}_{2} , {\overline{s}}_{2}^{′} ,\end{matrix} \\ ★ {\overline{s}}_{pre} , {\overline{s}}_{pre} , {\overline{s}}_{post} , {\overline{s}}_{post} have maximum length , respectively \\ \overline{s} ∇ {\overline{s}}^{′} = \begin{matrix}* & otherwise\end{matrix} \\ \hat{s} ∇ {\hat{s}}^{′} = \{ \begin{matrix}\hat{s} & if \hat{s} = {\hat{s}}^{′} \\ ⊔ \{ \overline{s} ∇ {\overline{s}}^{′} \vert \overline{s} ∈ \hat{s} , {\overline{s}}^{′} ∈ ( {\hat{s}}^{′} - \hat{s} ) \} & otherwise\end{matrix} \\ ★ \overline{s} ∈ \hat{SNF} , \hat{String} without any +$$

First, the concatenation operation performs joining two abstract strings.

That is, when a specific value is entered as a variable to be analyzed (Type 1), a corresponding value is inputted into the analysis result data.

On the other hand, if * (Type 3) or T (Type 4) is repeatedly entered as a value of a variable to be analyzed, the following operations are performed and the results are inputted into the analysis result data.
. . . *+* . . . = . . . * . . .
. . . T+T . . . = . . . T . . .

Here, * is an operator that means repetition, and T is an operator that means a value unknown due to an external input value. Accordingly, if any one of * and T is repeated several times, it can be expressed as one * or T since * and T do not contain length information.

If a variable to be analyzed can have two or more string values due to a conditional statement such as an if-then-else statement (Type 2), the join operation divides all values that can be entered suing “|” operator, and inputs the values into the analysis result data.

For example, with a conditional expression of an “if” statement, a variable “a” comes to have a string “abc” at a “then” statement and a string “123” at an “else” statement.

Therefore, since it should be analyzed that the variable “a” has a value of either “abc” or “123” after the if-then-else statement, the node analyzing part 242 inputs a union set of possible values (abc|123) into the analysis result data.

When a string value is repeatedly inputted by a loop statement such as a “while” statement (Type 3), the “widening” operation inputs * into the analysis result data.

For example, if a variable “A” that once had a value “aa” comes to have a value “aattt . . . t” after a certain loop statement has been performed, the node analyzing part 242 sets “aa*” as an abstract value of the variable “A”. Alternatively, if a variable “A” that once had a value “aa” comes to have a value “att . . . tta” after a certain loop statement has been performed, the node analyzing part 242 sets “a*a” as an abstract value of the variable “A”.

At this time, if the loop statement is an infinite loop statement, the node analyzing part 242 inputs only * into the analysis result data and terminates the loop statement since the loop repeats endlessly.

An abstract value extracted for each variable or object through such an abstract operation is an analysis result value of each node and comprises abstract strings in predetermined forms.

In an embodiment of the present invention, an analysis result value of a node comprises five types of abstract strings.

Type 1. General String

Type 1 is in a form that is not abstracted, and is a case where the value of a variable is fully known as follows.
1: String s=“fully known string”;
2: function(s);

The abstract string of the variable “s”, i.e., a parameter of a “function” function, is created as follows.
(expression) Type 1: [AbstractString]
(example) Type 1: “fully known string”

Type 2. OR String

Type 2 corresponds to a case where a variable can have two or more values due to a certain conditional statement that cannot be determined statically.
1: String s=“ ”;
2: if (condition)
3: s=“abcd”;
4: else
5: s= [symbol]
6: function(s);

The variable “s” has a value of either “abcd” or [symbol] by the conditional expression of the “if” statement. Accordingly, the abstract string of the variable “s”, i.e., the parameter of the “function” function, is created as follows.
(expression) Type 2: [AbstractString]|[AbstractString]
(example) Type 2: “(abcd”|

[symbol]

Type 3. Repetitive String

Type 3 is used when a value continuously increases by a loop statement.
1: String s=“head”;
2: while (condition)
3: {
4: s=s+“tail”;
5: }
6: function(s);

At this time, although the abstract string value of the variable “s” certainly starts with “head”, it is unknown that how many times the “tail” will be appended according to the conditional expression of the “while” statement.

Accordingly, repeated concatenation of a certain string is referred to as “BOTTOM” and is expressed using an * symbol as follows.
(expression) Type 3: [BOTTOM]
(example) Type 3: “head*”

Type 4. Unknown String (Top)

Type 4 is used when the value of a certain string cannot be known since a user inputs the value from the outside.
1: String s;
2: s=user_input( );
3: function(s);

Since the abstract string value of the variable “s” on the third line is determined by a value inputted by a user at the second line in an execution time, it cannot be known.

Accordingly, an unknown value is referred to as “TOP” and is expressed as follows.
(expression) Type 4: [TOP]
(example) Type 4: “Top”

Type 5. Repetition of Abstract String

Type 5 is used when the value of a variable to be analyzed is repeated with values of the abstract strings Type 1, Type 2, Type 3, and Type 4.

A plurality of abstract strings joined together as shown below can be used.
(expression) Type 5: [AbstractString], [AbstractString]

(Accordingly, the analysis result value of the current node comprises the aforementioned five types of abstract strings.)

The node analyzing part 242 uses the five types of abstract strings described above to express an analysis result value of a node.

The fixed-point determining part 243 receives an analysis result value of a current node from the node analyzing part 242, and determines whether a point where the current node is analyzed is a fixed point.

Here, a case where the point is determined to be a fixed point corresponds to a case where an environmental value of the current node accords with the result value of the current node extracted by the node analyzing part 242, or a case where the position of the current node accords with a point to be analyzed.

If it is determined that the point is a fixed point, the analysis of the current node is terminated, and the result value of the current node extracted as an analysis result is inputted into the analysis result processing part 244.

If it is determined that the point is not a fixed point, the result value of the current node is inputted into the node attribute identifying part 241 and thus becomes an environmental value of the next node needed for the analysis of the next node.

The analysis result processing part 244 stores the result value of the current node, which has been received from the fixed-point determining part 243, as analysis result data.

At this time, according to the purpose of an analysis, analysis result data contains not only analysis result data of a variable desired to be retrieved but also at least one of the location and characteristic of the variable.

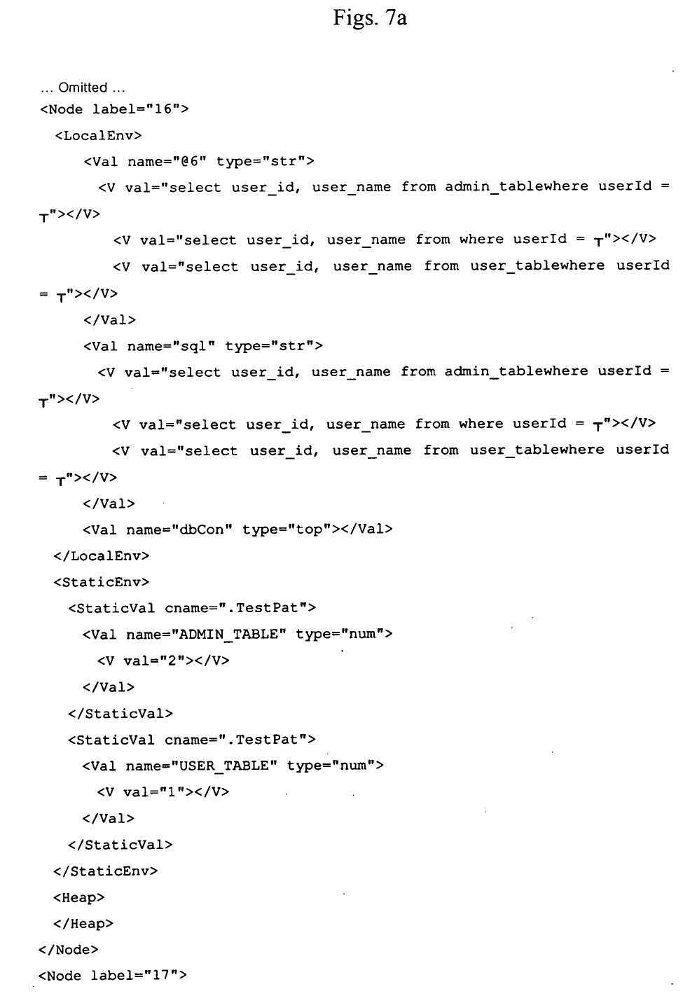

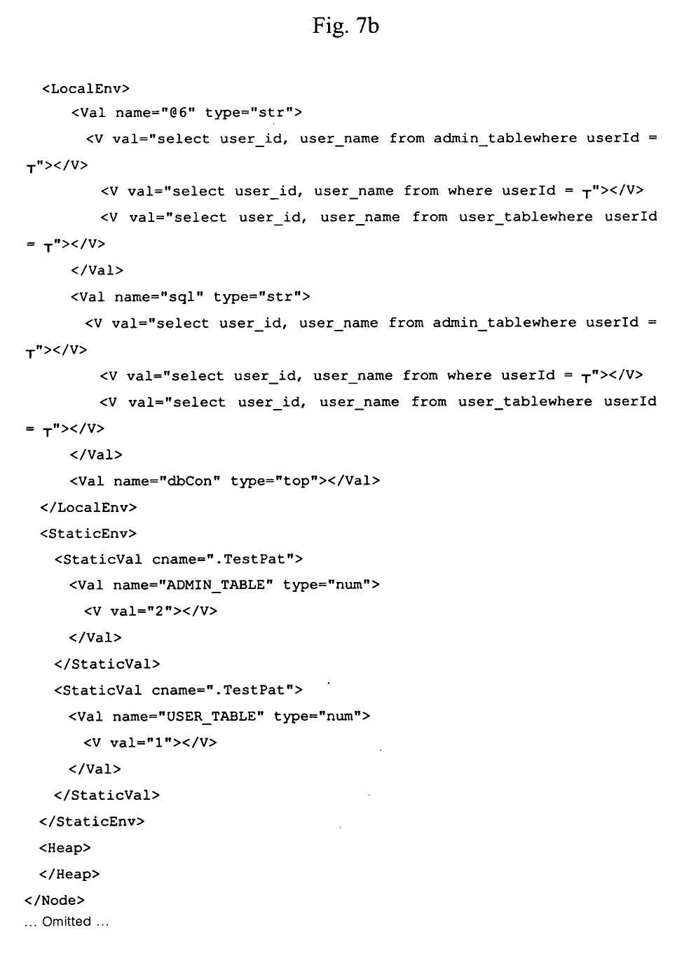

Referring to FIGS. 7a and 7b, there is shown an exemplary view of application of a string analyzer according to an embodiment of the present invention, wherein analysis result data stored as an XML document can be seen. In this way, analysis result data can be stored in at least one of an easily retrievable file, various databases, and an XML document.

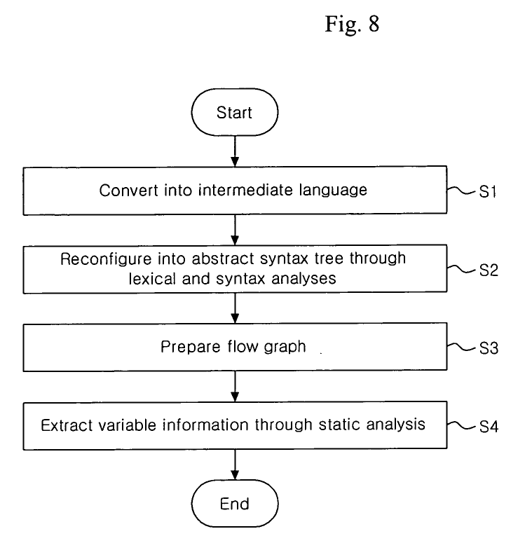

FIG. 8 is a flowchart illustrating the operation of the universal string analyzer shown in FIG. 2.

Referring to FIG. 8, the intermediate language conversion unit 220 converts a first data file 210 coded in a certain programming language into a second data file coded in a specific intermediate language (S1).

The parsing section 231 divides the second data file received from the intermediate language conversion unit 220 on a meaningful token basis, and reconfigures the tokens into data in an abstract syntax tree form representing the structure of the tokens through a syntax analysis (S2).

The preprocessing section 232 receives the data in the abstract syntax tree form reconfigured by the parsing section 231, and extracts flow information according to the dependency and precedence between individual operations of the program.

Then, the preprocessing section 232 prepares the extracted flow information into a flow graph for easy analysis (S3).

The string analysis section 233 performs a static analysis until a fixed point is determined for each node based on the flow graph, and prepares analysis result data of variable information at a certain or each point in the first data file (S4).

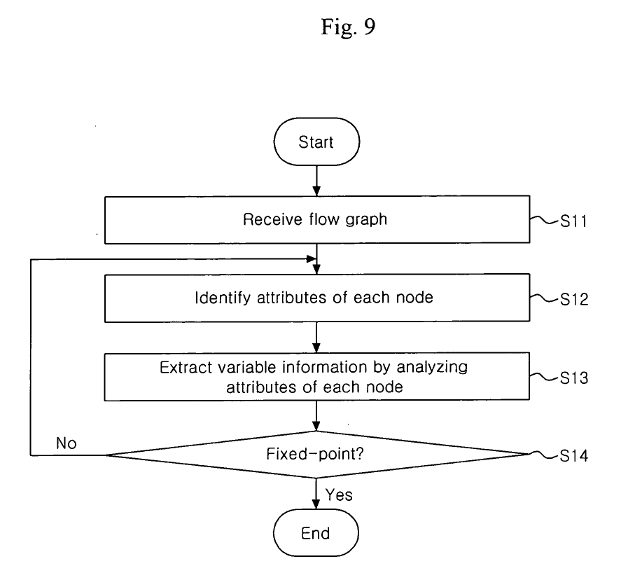

FIG. 9 shows a flowchart of the string analysis section 233 shown in FIG. 6.

Referring to FIG. 9, the string analysis section 233 receives a flow graph from the preprocessing section 232, and performs a static analysis for each node according to the flow information (S11).

The node attribute identifying part 241 receives a current node and an environmental value of the current node, identifies attributes of the current node, and sends the attributes to the node analyzing part (S12).

The node analyzing part 242 sends an analysis result value of the current node, which has been extracted by performing a static analysis according to the attributes of the current node, to the fixed-point determining part 243 (S13).

The fixed-point determining part 243 determines whether the analysis result value of the current node received from the node analyzing part 242 corresponds to the environmental value of the current node, or whether a point to be analyzed corresponds to the point of the current node (S14).

If it is determined that the analysis result value of the current node corresponds to the environmental value of the current node, or a point to be analyzed corresponds to the point of the current node, the analysis result value of the current node is stored as analysis result data by the analysis result processing part 244 (S15).

If it is determined that the analysis result value of the current node does not correspond to the environmental value of the current node, or a point to be analyzed does not correspond to the point of the current node, the analysis result value of the current node is inputted, as an environmental value of the next node, into the node analyzing part 242.

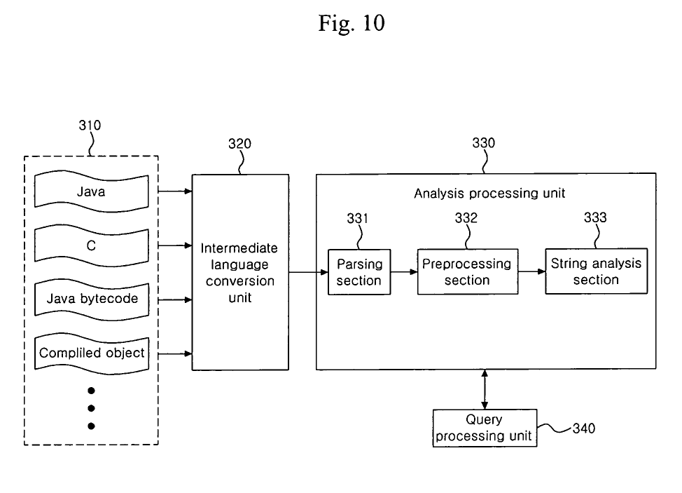

FIG. 10 is an exemplary view of application of a string analyzer according to another embodiment of the present invention.

Referring to FIG. 10, the string analyzer performs an analysis process of a string analyzer according to an embodiment of the present invention, and outputs analysis result data.

Then, the string analyzer outputs information on a variable corresponding to a query entered from the outside based on the corresponding analysis result data.

Accordingly, an intermediate language conversion unit 320 and an analysis processing unit 330 are blocks performing the functions illustrated in FIG. 2 and have been already explained in detail, and thus, only a query processing unit 340 will be explained.

The query processing unit 340 receives a query from the outside, and outputs variable information corresponding to the query, based on the analysis result data outputted by the analysis processing unit 330.

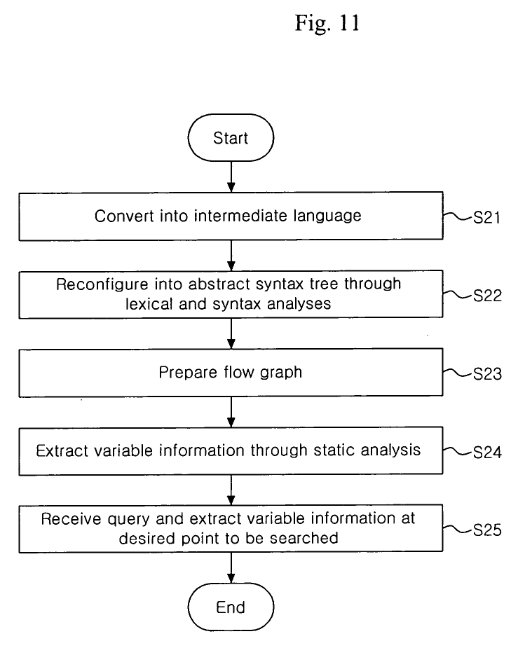

Here, the query processing unit 340 may be implemented to output variable information at a point to be searched, by receiving a query from the outside after the analysis process of the analysis processing unit 330 is completed (as shown in FIG. 11).

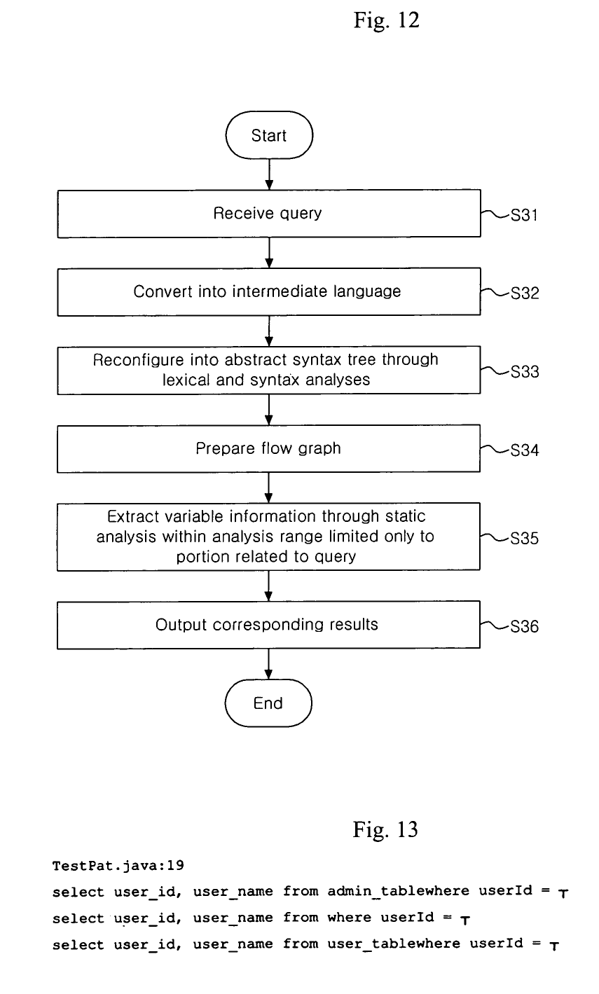

In addition, the query processing unit 340 may be implemented to output variable information at a point to be searched, by receiving a query from the outside before the analysis processing unit 330 performs an analysis process. In this case, the analysis processing unit 330 may be implemented to analyze only a portion related to the query (as shown in FIG. 12).

FIG. 11 is a flowchart showing a case where a query is received from a user after the analysis processing unit 330 completes all the analysis processes.

First, the intermediate language conversion unit 320 converts a first data file 310 into a second data file coded in an intermediate language (S21). That is, the intermediate language conversion unit 320 provided for various kinds of programming languages converts a first data file 310, which can be coded in one of various programming languages, into a second data file coded in a specific intermediate language, and outputs the second data file to the analysis processing unit 330.

A parsing section 331 divides the second data file on a meaningful token basis through a lexical analysis, reconfigures the tokens into data in an abstract syntax tree form through a syntax analysis, and outputs the data to a preprocessing section 332 (S22).

The preprocessing section 332 extracts flow information according to the dependency and precedence between individual operations in the program based on the data in an abstract syntax tree form. Then, the preprocessing section 332 converts the extracted flow information into a flow graph for easy analysis, and inputs the flow graph into a string analysis section 333 (S23).

The string analysis section 333 extracts variable information at a certain or each point in the first data file based on the flow graph, and prepares the information as analysis result data (S24).

At this time, the string analysis section 333 performs a static analysis in which a concrete value of a variable is estimated using an abstract value according to an abstract analysis method. As a result, the value of the analyzed variable is composed of the five types of abstract strings explained above, and is stored in a file, database, or XML document so that desired information can be outputted according to a query.

The query processing unit 340 outputs variable information corresponding to the inputted query based on the stored analysis result data (S25).

Here, all variable information at each point in the first data file is extracted and included in the analysis result data.

Accordingly, if the string analyzer receives a query after completing all the steps of S21 to S24, there is an advantage in that step S25 of outputting variable information corresponding to the query is performed at least once.

FIG. 12 is a flowchart showing a case where the query processing unit 340 receives a query from a user before the analysis processing unit 330 performs an analysis process.

Here, the analysis processing unit 330 is implemented to perform the analysis process only for a portion related to the query in order to save time required for outputting variable information corresponding to the query. However, the present invention is not limited thereto.

First, the query processing unit 340 receives a query from a user (S31).

The intermediate language conversion unit 320 converts a first data file 310 into a second data file coded in a specific intermediate language (S32).

The parsing section 331 reconfigures the second data file into data in an abstract syntax tree form through lexical and syntax analyses (S33). Then, the preprocessing section 332 converts the data in an abstract syntax tree form into a flow graph to know flow information (S34).

The string analysis section 333 statically analyzes only a portion related to the query based on the flow graph (S35).

Then, the query processing unit 340 outputs the information analyzed by the string analysis section 333 as results of the corresponding query (S36).

Accordingly, the string analyzer of FIG. 12 analyzes only the portion related to the query and outputs the results of the corresponding query, and thus, has an advantage in that an analysis speed is higher than that of the string analyzer of FIG. 11.

Examples of queries inputted into the query processing unit 340 are listed below.
1: SomeObject obj=new SomeObject( );
2: obj.str=“hello”;
3: obj.str+=“world”;
4: obj.exec( );

When a specific variable (str) on line 3 is to be searched in a program coded as shown above, a query may be expressed as follows.
Type1Search exam1
   =new Type1Search(c1File1, 3, “obj.str”);
      // (file name, line number, corresponding variable)
Type2Search exam2
   =new Type2Search(c1File1, 3, “obj.str”);
      // (file name, line number, corresponding variable)

This code is an example of a query for getting the value of a variable str contained in an object obj on the third line in a file c1FileName.

At this time, an object Type1Search receives a query (c1File1, 3, “obj.str”), and outputs a value that is set before corresponding line 3 is executed. Then, an object Type2Search receives a query (c1File1, 3, “obj.str”), and outputs a value that is set after corresponding line 3 is executed.

Therefore, exam1 has the value (“hello”) of the variable str according to the object Type1Search, and exam2 has the value (“hello world”) of the variable str according to the object Type2Search.

In addition, when the value of a variable in a function of a specific object is to be searched, a query may be expressed as follows.
Type3Search exam3
=new Type3Search(c1File1,“<SomeObject: void exec(String)>, “obj.str”);
   // (file name, corresponding object and function, corresponding variable)

This is an example of a query for searching for the value of the variable str of the object obj when an “exec” function of an object SomeObject in the file c1File1 is executed.
1: String a=“abcd”;
2: Target t=new Target( );
3: t.testMethod(a, 100);

When the value of the first parameter “a” among parameter values (a, 100) of a function testMethod in the program (referred to as c2File2) coded as shown above is intended to be known, a query may be expressed as follows.
Type4Search exam4
=new Type4Search(c2File2, “<Target: void testMethod(String,int)>”, 1);
   // (file name, <corresponding class and function>, n^{th} parameter)

As described above, a query can be implemented in a variety of forms according to desired information. Accordingly, the query processing unit 340 receives such a query, derives desired information from analysis result data of a file to be searched, and outputs the information.

Referring to FIG. 13, there is shown an example in which the query processing unit 340 queries the value of sq1 (a parameter of a function pareStatement in an object dbCon on the 20th line of the first data file) of the first data file shown in FIG. 3, and derives results. At this time, the output data shown in FIG. 13 is an output of the value of sq1 on the 20th line of the first data file derived from the analysis result data of the first data file (shown in FIGS. 7a and 7b).

Accordingly, three types of values of sq1 are outputted due to the if-else conditional statement in the first data file (shown in FIG. 3).

Since the string analyzer according to the other embodiment of the present invention operates the query processing unit 340 in such a manner, it is possible to manage various application programs and database systems complexly associated through inter-dependency so that integrity can be maintained.

Here, a variable that can be searched from the outside through the query processing unit 340 is information on a variable that is stored in a memory and has its address. The variable may be at least one of a string at a certain or at each point in a program, a database query statement, a static variable, a general variable, an object, a function, a variable and function in an object, a variable in a function, and a parameter in a function.

For example, when an administrator intends to add or modify a field of a certain table in a database, the administrator should search and modify all application programs that use the corresponding database.

At this time, the string analyzer according to the other embodiment of the present invention has stored analysis result data of each application program so that a query can be searched. Accordingly, the administrator enters a query for deriving the value of a desired variable into the query processing unit 340 of the string analyzer, and consequently receives a set of the values of the desired variable.

Therefore, the administrator can effectively find inter-dependency between a plurality of application programs and databases. According to the present invention, the string analyzer extracts flow information of a variable (variable information at a certain or each point) in a target program to be analyzed, thereby estimating the value of each variable by statically analyzing the information in consideration of a path along which the program follows upon actual execution of the program.

In addition, the string analyzer stores and manages the statically analyzed information as analysis result data, and shows the variable information according to an input query based on the analysis result data. Accordingly, an administrator can repeatedly get the variable information at a certain or each point in the target program without waiting for time required for every analysis performed by the string analyzer.

In addition, if a string analyzer is developed to convert target programs to be analyzed, which are coded in various programming languages (Java bytecode coded in an intermediate language of a Java virtual machine, EXE coded in a machine language, DLL) into forms coded in one intermediate language and to perform a static analysis, there is an advantage of improvement of compatibility with the target programs.

On the other hand, if a string analyzer is developed to perform a static analysis exclusively to a target program to be analyzed, which is coded in a specific programming language, a load on an analysis process is decreased, so that it can be performed in a low specification computing system.

Meanwhile, the string analyzer automatically extracts information on program components, such as include files, functions, databases, objects, and the like, of a target program to be analyzed, and shows a variety of variable information (a string at a certain or each point of a program, a database query statement, a static variable, a general variable, an object, a function, a variable and function in an object, a variable and parameter in a function) of each of the components.

Accordingly, an administrator can analyze the relationship between resources of application programs and databases (information on tables, columns, and views), and thus can effectively perform modification management, effect analysis, quality control, and product management upon development of an application.

In other words, from the viewpoint of an administrator, a universal string analyzer according to an embodiment of the present invention is advantageous to cost reduction upon maintenance of an application, effective integrated-management of resources, error prevention through preliminary crosscheck upon modification of an application, efficient human resource management through prompt takeover, and quality control.

In addition, from the viewpoint of a developer and an operator, a string analyzer according to an embodiment of the present invention is advantageous to an automated as-is analysis upon development of an application, an effect analysis upon modification of a program or database, program backup and history management of an application and a database, and increase in productivity through elimination of simple repetitive processes upon development of an application.

In addition, from the viewpoint of a quality control supervisor, a string analyzer according to an embodiment of the present invention supports establishment of standardized quality criteria and consistency verification of an application, error prevention upon modification of an application, and automatic generation and analysis of a product for each quality-related process.

In addition, from the viewpoint of a project manager, a string analyzer according to an embodiment of the present invention enables reinforcement of project control through efficient management of development, an automated as-is analysis upon development of an application, reduction in human resources and development time through automatic generation of a product, enhancement of user's satisfaction through quality control, easy and prompt takeover of works due to on-line documentation of an application.

Although the present invention has been described and illustrated in connection with the specific preferred embodiments, it will be readily understood by those skilled in the art that other different embodiments also fall within the spirit and scope of the present invention.

For example, in the embodiments of the present invention, the string analyzer is implemented such that a target program to be analyzed is analyzed after being converted into a form coded in an intermediate language ( [symbol] language), whereby all programs coded in a plurality of programming languages can be analyzed.

Accordingly, the string analyzer according to the embodiment of the present invention is provided with an intermediate language conversion unit 220 or 320 for each programming language. However, it is not limited thereto. For example, the string analyzer can be selectively provided with an intermediate language conversion unit for converting a programming language into an intermediate language.

In addition, the string analyzer may be implemented to directly perform a static analysis for a target program to be analyzed, which is coded in one programming language, without an additional intermediate language conversion unit for converting the target program into a form coded in an intermediate language.

At this time, the target program coded in a programming language may be any one of a Java file, a C++ file, a C#.NET file, a PL/1 file, a COBOL file, a JCL file, a JSP file, a Delphi file, a Visual Basic file, a PowerBuilder file, a Java bytecode file coded in an intermediate language of a Java virtual machine, an EXE file coded in a machine language, and a DLL file.

Therefore, since a string analyzer is exclusively responsible for one programming language, the size of the string analyzer itself is reduced. In this case, there is an advantage of reduction in a load on a computing system operating the string analyzer.

What is claimed is:

1. A universal method of analyzing a string, the method comprising:
converting a first data file coded in a programming language into a second data file coded in a specific intermediate language; and
extracting flow information related to execution sequence from strings contained in the second data file;
performing a static analysis according to the flow information; and
storing variable information at a given or each point as analysis result data.

2. The method as claimed in claim 1, wherein the extracting, performing, and storing steps comprise an analysis processing step, wherein the analysis processing step further comprises:
a parsing step of reconfiguring the strings of the second data file into abstract syntax tree data representing a structure of a target program to be analyzed, through lexical and syntax analyses;
a preprocessing step of extracting flow information from the parsed data and creating a flow graph; and
a string analysis step of statically analyzing the preprocessed data, extracting variable information estimated at each point based on the flow graph, and preparing the analysis result data.

3. The method as claimed in claim 2, wherein the string analysis step comprises:
a node attribute identifying step of receiving each node and an environmental value of the node according to the execution sequence from the strings contained in the second data file, and identifying attributes of the node;
a node analyzing step of statically analyzing the node and outputting a resulting value of the node;
a fixed-point determining step of determining whether a point where the node is analyzed is a fixed point where the value of a variable to be analyzed is estimated to be a fixed value, based on the resulting value obtained through the node analysis; and
an analysis result processing step of outputting the analysis result value of the node as the analysis result data if it is determined in the fixed-point determining step that a point where the node is analyzed is a fixed point.

4. The method as claimed in claim 3, wherein the fixed-point determining step comprises determining a point as a fixed point if a result environment of a previous node is identical with that of a current node or the position of the current node corresponds to a point to be analyzed while the analysis is performed.

5. The method as claimed in claim 1, further comprising a query processing step of receiving a query for searching for at least one piece of information among variables in the first data file, and extracting information corresponding to the query from the analysis result data.

6. The method as claimed in claim 5, wherein the query processing step comprises receiving a query, and extracting information corresponding to the query from the analysis result data obtained in the analysis processing step in which the analysis process is performed by analyzing the first data file.

7. The method as claimed in claim 5, wherein the query processing step comprises receiving a query, and extracting information corresponding to the query from the analysis result data obtained in the analysis processing step in which the analysis process is performed by analyzing a range limited to a portion related to the query.

8. The method as claimed in claim 1, wherein the first data file is any one of a data file coded in one selected among Java, C++, C#.NET, PL/1, COBOL, JCL, JSP, Delphi, Visual Basic and PowerBuilder; a Java bytecode file coded in an intermediate language of a Java virtual machine; an EXE file coded in a machine language; and a DLL file.

9. The method as claimed in claim 1, wherein the analysis result data are stored in at least one of a file, a database, and an XML document.

10. The method as claimed in claim 1, wherein the analysis result data are composed of an abstract string in a predetermined form representing variable information at one or more points or each point in the second data file.

11. The method as claimed in claim 10, wherein the abstract string in the predetermined form comprises:
a first abstract string representing a value of a variable extracted as a single value through a static analysis;
a second abstract string representing possession of one of one or more values of a variable due to a conditional expression during execution of the static analysis, the second abstract string being composed of a set of values that the variable can have;
a third abstract string representing continuous increase of a string value of a variable due to a loop statement during execution of the static analysis, the third abstract string being composed of a pattern of repeated values that can be a value of the corresponding variable;
a fourth abstract string representing a value of a variable inputted from the outside; and
a fifth abstract string representing a string value of a variable repeated with the first to fourth abstract strings.

12. A computer readable medium including a universal string analyzer, the universal string analyzer comprising:
first code to convert a first data file coded in a given programming language into a second data file coded in a specific intermediate language; and
second code to extract flow information related to execution sequence from strings contained in the second data file;
third code to perform a static analysis according to the flow information; and
fourth code to store variable information at one or more points or each point as analysis result data.

13. The computer readable medium of claim 12, wherein the first, second, third, and fourth codes to convert, extract, perform and store are associated with an analysis processing unit, where the analysis processing unit further comprises:
first sub-code to reconfigure the strings of the second data file into abstract syntax tree data representing a structure of a target program to be analyzed through lexical and syntax analyses;
second sub-code to extracte flow information from the parsed data and create a flow graph; and
third sub-code to statically analyze the preprocessed data, extract variable information estimated at each point based on the flow graph, and prepare the analysis result data.

14. The computer readable medium of claim 13, wherein the third sub-code is associated with a string analysis section, wherein the string analysis section further comprises:
fourth sub-code to receive each node and an environmental value of the node according to the execution sequence from the strings contained in the second data file, and identifying attributes of the node;
fifth sub-code to statically analyze the node and outputting a resulting value of the node;
sixth sub-code to determine whether a point where the node is analyzed is a fixed point where the value of a variable to be analyzed is estimated to be a fixed value based on the resulting value obtained by the node analyzing part; and
seventh sub-code to output the analysis result value of the node as the analysis result data if it is determined by the sixth sub-code that a point where the node is analyzed is a fixed point.

15. The computer readable medium of claim 14, wherein the sixth sub-code determines a point as a fixed point if a result environment of a previous node is identical with that of a current node or the position of the current node corresponds to a point to be analyzed while the analysis is performed.

16. The computer readable medium of claim 14, wherein the first, second, and third sub-codes are associated with a parsing section, preprocessing section, a string analysis section, respectively, wherein the fourth, fifth, sixth, and seventh sub-codes are associated with a node attribute identifying part, a node analyzing part, a fixed point determining part, an analysis result processing part, respectively.

17. A universal method of analyzing a string, the method comprising:
a parsing step to reconfigure a string of a data file coded in a programming language into abstract syntax tree data representing a structure of a target program to be analyzed, through lexical and syntax analyses;
a preprocessing step to extract flow information from the parsed data, and creating a flow graph; and
a string analysis step to statically analyze the preprocessed data, extract variable information estimated at each point based on the flow graph, and prepare analysis result data.

18. The method as claimed in claim 17, wherein the analysis result data comprise an abstract string in a predetermined form representing variable information at one or more points or each point in the data file.

19. A computer readable medium including a string analyzer, the string analyzer comprising:
a parsing section to reconfigure a string of a data file coded in a programming language into abstract syntax tree data representing a structure of a target program to be analyzed, through lexical and syntax analyses;
a preprocessing section to extract flow information from the parsed data, and creating a flow graph; and
a string analysis section to statically analyze the preprocessed data, extracting variable information estimated at each point based on the flow graph, and preparing analysis result data.

20. A computer-readable recording medium on which a program for executing functions in a computer including a microprocessor is recorded, the program comprising:
code to convert a first data file coded in a programming language into a second data file coded in a specific intermediate language; and
code to extract flow information related to execution sequence from strings contained in the second data file, perform a static analysis according to the flow information, and store variable information extracted at a certain or each point as analysis result data.
